(19) United States
(12) Patent Application Publication
(10) Pub. No.: US 2019/0220032 A1
(43) Pub. Date: Jul. 18, 2019

(54) AUTONOMOUS DELIVERY SYSTEM WITH AUTONOMOUS DELIVERY VEHICLES AND DEDICATED DELIVERY RECEIVING STATIONS

(71) Applicant: Eliport, Inc., Barcelona (ES)

(72) Inventor: Dmitry Skorinko, Barcelona (ES)

(21) Appl. No.: 15/874,871

(22) Filed: Jan. 18, 2018

(51) Int. Cl. G05D 1/02; G05D 1/00; G06Q 10/08

(52) U.S. Cl. CPC G05D 1/0225; G05D 1/0088; B60R 25/01; G06Q 10/083; G05D 1/0246

(57) ABSTRACT

An autonomous delivery system includes an autonomous delivery vehicle and a dedicated delivery receptacle at a delivery location. The autonomous delivery vehicle autonomously delivers a delivery item to the delivery location and autonomously transfers the delivery item to the delivery receptacle.

### BACKGROUND

The dramatic growth of e-commerce has given rise to a significant increase in the number of parcel deliveries. Billions of parcels are delivered to homes and businesses each year, and the number of deliveries will continue to increase at a rapid rate. Currently the last leg of these parcel deliveries typically is effected by a human courier transporting the goods from a logistics hub or a store to their final destination, such as a home or business. This last leg of the supply chain is the least efficient and most expensive part of the journey, often accounting for up to 50% of the total cost to move goods. In addition, the use of human couriers to deliver packages has other disadvantages. Humans make mistakes and packages get lost in transit. Packages left outside houses are subject to weather damage and vulnerable to theft. Unsuccessful delivery attempts have become a significant issue among dedicated courier companies as well as the in-house delivery fleets of supermarket/grocery stores. This leads to unnecessary cost increases and resource wastage.

Autonomous delivery vehicles have been proposed but they fail to address an important problem—how to efficiently and autonomously unload the parcel at the delivery location such that the parcel is kept secure and protected from the elements at the delivery location.

### SUMMARY

Illustrative aspects of the present disclosure are directed to an autonomous delivery system that includes an autonomous delivery vehicle and a delivery receptacle. The delivery receptacle is disposed at a delivery location. The autonomous delivery vehicle autonomously transports a delivery item to the delivery location and autonomously transfers the delivery item to the delivery receptacle.

Other illustrative aspects of the present disclosure are directed to an autonomous delivery system that includes an autonomous delivery vehicle, a dedicated delivery container, and a container docking station. The dedicated delivery container is configured to store one or more items to be delivered. The autonomous delivery vehicle autonomously transports the dedicated delivery container to a delivery location. The container docking station is disposed at the delivery location and includes a container-securing mechanism. The autonomous delivery vehicle transfers the dedicated delivery container to the container-securing mechanism of the docking station such that the dedicated delivery container is secured in place by the container-securing mechanism.

Other illustrative aspects of the present disclosure are directed to an autonomous delivery system that includes an autonomous delivery vehicle and a dedicated delivery opening in an outer wall of a building structure. The autonomous delivery vehicle autonomously transports a delivery item and autonomously transfers the delivery item through the dedicated delivery opening in the building structure.

### BRIEF DESCRIPTION OF THE DRAWINGS

FIG. 1 is a simplified three-dimensional drawing of an autonomous delivery vehicle in accordance with an illustrative embodiment of the present disclosure.

FIG. 2 is a simplified three-dimensional drawing of a delivery receptacle in accordance with an illustrative embodiment of the present disclosure.

FIG. 3 is a perspective view of an autonomous delivery vehicle approaching a delivery receptacle in accordance with an illustrative embodiment of the present disclosure.

FIGS. 4a and 4b are plan views showing an autonomous delivery vehicle opening a delivery receptacle in accordance with an illustrative embodiment of the present disclosure.

FIGS. 5a and 5b are plan views showing an autonomous delivery vehicle opening a delivery receptacle in accordance with another illustrative embodiment of the present disclosure.

FIGS. 6a and 6b are plan views showing an autonomous delivery vehicle unloading a delivery item into a delivery receptacle using an electromechanical pushing arm in accordance with an illustrative embodiment of the present disclosure.

FIGS. 7a and 7b are plan views showing an autonomous delivery vehicle unloading a delivery item into a delivery receptacle using a floor comprising rollers in accordance with an illustrative embodiment of the present disclosure.

FIGS. 8a and 8b are plan views showing an autonomous delivery vehicle unloading a delivery item into a delivery receptacle using a floor comprising a moving belt in accordance with an illustrative embodiment of the present disclosure.

FIGS. 9a and 9b are plan views showing an autonomous delivery vehicle unloading a delivery item into a delivery receptacle using an inclining floor in accordance with an illustrative embodiment of the present disclosure.

FIG. 10 is a perspective view of a dedicated delivery opening in an exterior wall of a house in accordance with an illustrative embodiment of the present disclosure.

FIG. 11 is a perspective view of a dedicated delivery opening in a fence in accordance with an illustrative embodiment of the present disclosure.

FIG. 12 is a perspective view of a delivery container in accordance with an illustrative embodiment of the present disclosure.

FIG. 13 is a perspective view of an autonomous delivery vehicle configured to deliver a delivery container in accordance with an illustrative embodiment of the present disclosure.

FIG. 14 is a perspective view of an autonomous delivery vehicle carrying a delivery container in accordance with an illustrative embodiment of the present disclosure.

FIG. 15 is a perspective view of an autonomous delivery vehicle carrying a delivery container and approaching a container docking station in accordance with an illustrative embodiment of the present disclosure.

FIG. 16 is a perspective view of an autonomous delivery vehicle unloading a delivery container to a container docking station in accordance with an illustrative embodiment of the present disclosure.

FIG. 17 is a perspective view of an autonomous delivery vehicle leaving a container docking station after unloading a delivery container in accordance with an illustrative embodiment of the present disclosure.

FIG. 18 is a perspective view of a delivery container in accordance with an illustrative embodiment of the present disclosure.

FIG. 19 is a perspective view of an autonomous delivery vehicle configured to deliver a delivery container in accordance with an illustrative embodiment of the present disclosure.

FIG. 20 is a perspective view of an autonomous delivery vehicle carrying a delivery container in accordance with an illustrative embodiment of the present disclosure.

FIG. 21 is a perspective view of an autonomous delivery vehicle carrying a delivery container and approaching a container docking station in accordance with an illustrative embodiment of the present disclosure.

FIG. 22 is a perspective view of an autonomous delivery vehicle unloading a delivery container to a container docking station in accordance with an illustrative embodiment of the present disclosure.

FIG. 23 is a perspective view of an autonomous delivery vehicle leaving a container docking station after unloading a delivery container in accordance with an illustrative embodiment of the present disclosure.

### DETAILED DESCRIPTION

This disclosure addresses the problems inherent in existing parcel delivery schemes by providing autonomous delivery systems that make use of autonomous delivery vehicles that are configured to deliver items to one or more delivery locations and to autonomously unload the items at the delivery location(s). In various illustrative embodiments, the autonomous delivery vehicle unloads a delivery item by transferring the item to a dedicated delivery receptacle or a delivery container docking station.

It is anticipated that a primary use of the autonomous delivery systems and methods described herein may be parcel delivery. But the autonomous delivery systems and methods described herein can be employed to deliver substantially any kind of item.

In an illustrative embodiment of the present disclosure, the delivery vehicles are fully autonomous. “Autonomous,” as used herein, means that the vehicle is capable of carrying out its functions without human intervention. The autonomous delivery vehicles may at times herein be referred to as “robots,” or described as “robotic.” The term “robot,” as used herein, likewise means that the vehicle is capable of performing its functions without human assistance. The autonomous delivery vehicles of the present disclosure illustratively include one or more microprocessors that control the functions of the autonomous delivery vehicle. The microprocessor(s) runs software programs, illustratively including an operating system and autonomous vehicle control systems, that include instructions that effect the control of the mechanical apparatus of the autonomous delivery vehicle. In illustrative embodiments, the autonomous delivery vehicles include sensors, illustratively including optical sensors and/or cameras. These sensors, in conjunction with the vehicle's software control systems, enable the autonomous delivery vehicle to orient itself in its environment, make decisions regarding direction of travel, and carry out its main functions. In illustrative embodiments, the vehicle's software control systems include an autonomous navigation system that allows the vehicle to navigate in cities and suburban pedestrian spaces.

In certain embodiments of the present disclosure, the delivery vehicles are not fully autonomous but rather semi-autonomous. “Semi-autonomous,” as used herein, means that a human operator at a remote or nearby location controls aspects of the vehicle's functions via remote control.

In the preferred embodiments of the present disclosure, the autonomous delivery vehicles are ground-based, i.e., not aerial. The autonomous delivery vehicles are mobile, which as used herein means they are able to move, are agile, can turn, and can change directions. The vehicle's means of locomotion can be any of a variety of locomotion means, including wheels, continuous track systems, skis, legs, or any other locomotion means. In an alternative embodiment, an autonomous delivery vehicle can be aerial, i.e., can fly. In another embodiment, an autonomous delivery vehicle can be a near-ground vehicle that travels near the ground without actually touching the ground, such as vehicles that use hover technology, for example.

In illustrative embodiments of the present disclosure, the autonomous delivery vehicles are dedicated delivery vehicles, meaning they are specifically configured to perform item delivery, such as parcel delivery, as their primary function. The autonomous delivery vehicles are specifically configured to carry an item such as a parcel, package, box, or good from one point to another. In certain embodiments, the autonomous delivery vehicle is specifically configured to carry a dedicated container that is configured to, in turn, carry an item such as a parcel, package, box or good. In an illustrative embodiment, this dedicated container is likewise specifically configured to be carried by the autonomous delivery vehicle.

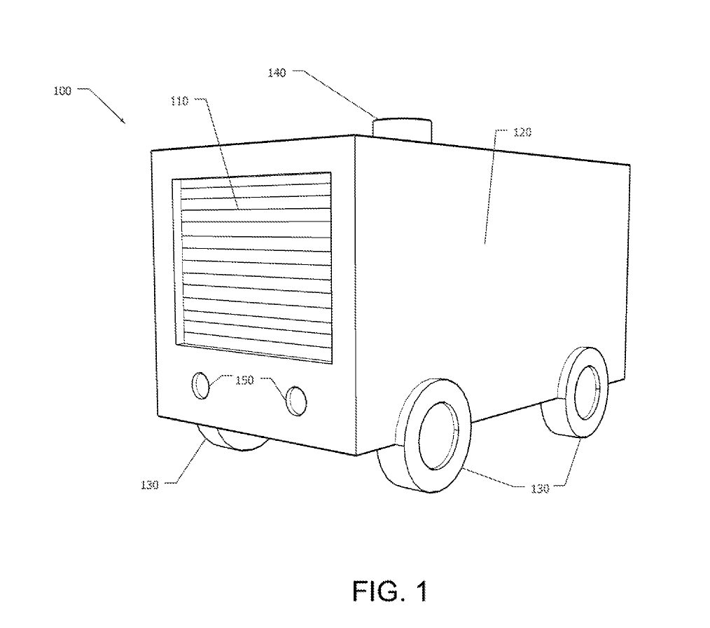

FIG. 1 is a simplified three-dimensional drawing of an autonomous delivery vehicle in accordance with an illustrative embodiment of the present disclosure. It is to be understood that the autonomous delivery vehicle 100 depicted in FIG. 1 is merely illustrative and that an autonomous delivery vehicle can take on any of a number of forms and configurations in accordance with the present disclosure, as explained above. The illustrative autonomous delivery vehicle 100 includes a door 110 that opens into a storage compartment 120. The autonomous delivery vehicle 100 further includes wheels 130, an optical sensor element 140, and cameras 150.

The autonomous delivery vehicle 100 can be loaded by opening the door 110 and loading one or more delivery items into the storage compartment 120. In an illustrative embodiment, this loading is performed by a human user. In various embodiments, the human user can open and close the door manually, or by pushing a button on the autonomous delivery vehicle 100, or via a wireless communication signal transmitted via a remote control unit, or by other means. In another illustrative embodiment, the loading of the autonomous delivery vehicle is performed autonomously via a process akin to one of the processes used to unload the vehicle as will be described below.

The control system of the autonomous delivery vehicle 100 is provided with information regarding a delivery destination for the item(s) being delivered. This delivery destination information illustratively includes a street address. In an illustrative embodiment, a human user provides the delivery destination information to the autonomous delivery vehicle 100. In various embodiments, the human user provides the delivery destination information via a wireless communication signal sent from a remote control unit, or via a keypad disposed on the autonomous delivery vehicle 100, or by other means. In another embodiment, the delivery destination information is wirelessly transmitted to the autonomous delivery vehicle from a central control station. In yet another embodiment, the storage compartment 120 of the autonomous delivery vehicle 100 contains sensing technology that enables it to autonomously acquire the delivery destination information from the delivery item itself. In various embodiments, such sensing technology can include radio-frequency identification (RFID) technology, optical reading technology, bar-code scanning, or other data sensing technologies.

The navigation system of the autonomous delivery vehicle 100 uses the delivery destination information, along with a positioning system such as the Global Positioning System (GPS) and a three-dimensional digital map library, to navigate the path travelled by the autonomous delivery vehicle 100 to reach the delivery destination for the item being delivered. The navigation system communicates with a motor that drives the rotation of the wheels 130. The navigation system also communicates with a steering module that controls the steering of the wheels 130.

The optical sensor element 140 and the cameras 150 gather information on the physical surroundings of the autonomous delivery vehicle 100 and provide it to the vehicle's navigation system. In an illustrative embodiment, the optical sensor element 140 comprises a LiDAR (Light Detection And Ranging) sensor. LiDAR is a three-dimensional optical sensing technology that enables automated features and autonomous driving. The navigation system uses the information obtained by the optical sensor element 140 and the cameras 150 to assist in navigating the course of the autonomous delivery vehicle 100, and to enable the autonomous delivery vehicle 100 to avoid and navigate obstacles.

In an illustrative embodiment of the present disclosure, an autonomous delivery vehicle such as autonomous delivery vehicle 100 is capable of autonomously unloading an item being delivered, i.e., without human interaction. In one embodiment, the autonomous delivery vehicle autonomously unloads the delivery item near a door of a residence or place of business. In another embodiment, the autonomous delivery vehicle unloads itself on a special marked unloading area that may be near a door or may be in another area adjacent the home or business.

In an illustrative embodiment of the present disclosure, the autonomous delivery vehicle autonomously unloads delivery items into dedicated delivery receptacles, or storage units, that are located at a delivery location. The delivery receptacles protect delivered items from adverse weather conditions and prevent delivered items from being stolen. A delivery receptacle can also be referred to as a storage unit, a box, a hub, a trunk, a parcelbox, a station, or a locker.

In an illustrative embodiment, the delivery receptacle has a door or a gate that is specially designed to be able to connect and interact with the autonomous delivery vehicle. The autonomous delivery vehicle is configured to open the receptacle door and unload a delivery item or items into the delivery receptacle. In an alternative embodiment, the delivery receptacle has a one-way access mechanism and the autonomous delivery vehicle pushes or puts the delivery item through this one-way access mechanism.

In an illustrative embodiment, the delivery receptacle can also be opened by human users, such as by the owner/beneficiary of the delivery receptacle, to retrieve delivered items placed in the receptacle by the autonomous delivery vehicle, or by a human courier to place a delivered item in the receptacle. While humans can use the same door to load and unload the delivery receptacle that the autonomous delivery vehicle uses to load the receptacle, in another embodiment, the delivery receptacle has a second door for humans to use to access the receptacle.

In an illustrative embodiment, the delivery receptacle is a stand-alone unit that can be positioned outside a home or business in a location that is convenient for receiving deliveries. In one embodiment the delivery receptacle is a movable unit, while in another embodiment the delivery receptacle is fixed in a specific location in a permanent or semi-permanent manner. In still another embodiment, the delivery receptacle is built into a house, wall, or any other type of permanent or temporary construction.

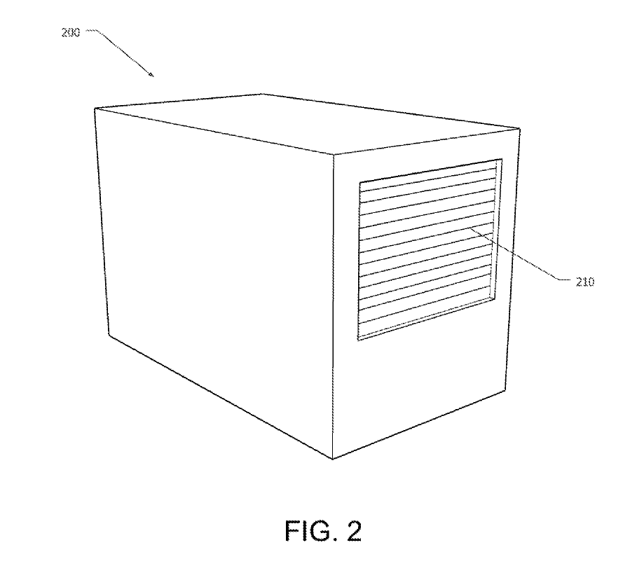

FIG. 2 is a simplified three-dimensional drawing of a delivery receptacle in accordance with an illustrative embodiment of the present disclosure. It is to be understood that the delivery receptacle 200 depicted in FIG. 2 is merely illustrative and that a delivery receptacle can take on any of a number of forms and configurations in accordance with the present disclosure, as explained above. The illustrative autonomous delivery vehicle 200 includes a door 210 that provides access to the delivery receptacle 210.

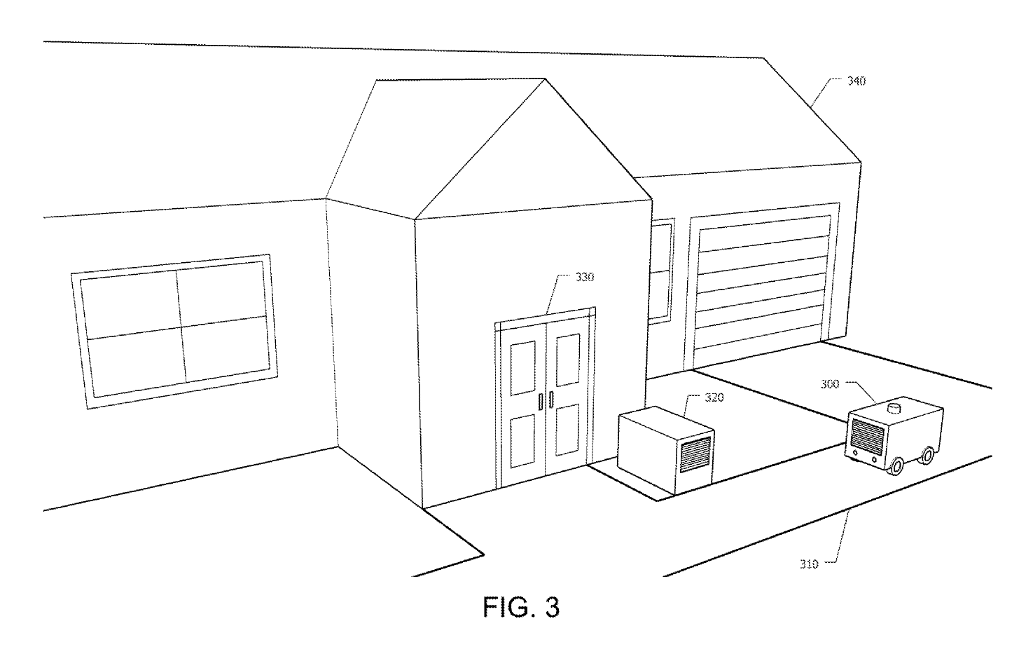

FIG. 3 is a perspective view of an autonomous delivery vehicle approaching a delivery receptacle in accordance with an illustrative embodiment of the present disclosure. The autonomous delivery vehicle 300 is travelling on a residential sidewalk 310. The delivery receptacle 320 is disposed near the front door 330 of a residence 340. As mentioned, the delivery receptacle 320 can be either a movable unit or can fixed in a specific location in a permanent or semi-permanent manner.

In an illustrative embodiment of the present disclosure, the navigation system of the autonomous delivery vehicle navigates to the delivery location based on delivery destination information such as a street address, as previously described. Once at the delivery location, the autonomous delivery vehicle can locate the delivery receptacle and its door using a variety of methods. In one embodiment, the delivery receptacle has visual markers or cues disposed on it. Such visual markers can include color markers or sign markers. The autonomous delivery vehicle uses a camera or cameras, such as the cameras 150 shown in FIG. 1, to provide images to the software control system of the autonomous delivery vehicle. The control system identifies the visual markers on the delivery receptacle and causes the autonomous delivery vehicle to position itself adjacent the door of the delivery receptacle. In another embodiment, the delivery receptacle has a scanning code, such as a QR code or other type of barcode, disposed on it that allow the vehicle's camera(s) and control system to locate the delivery receptacle. In another embodiment, the delivery receptacle transmits a wireless signal (using Bluetooth or any other radio technology or any other wireless communication technology) that serves as a beacon signal. In this embodiment, the autonomous delivery vehicle has a wireless receiver that detects the beacon signal and the vehicle's control software guides the vehicle towards the beacon signal based on parameters of the received signal such as the strength of the received signal.

In an illustrative embodiment of the present disclosure, the door of the delivery receptacle locks automatically upon closing. In this embodiment, the door of the receptacle must be unlocked by the autonomous delivery vehicle before the vehicle can unload a delivery item into the receptacle. In one embodiment, the autonomous delivery vehicle uses a mechanical key to unlock the door of the delivery receptacle. In another embodiment, the autonomous delivery vehicle uses a magnetic key to unlock the door of the delivery receptacle. In another embodiment, the autonomous delivery vehicle communicates with the delivery receptacle via a wireless communication signal and the delivery receptacle unlocks its door in response to this signal. In an illustrative embodiment, the unlocking of the delivery receptacle door also causes the door to physically open, while in an alternative embodiment, additional steps must be taken to physically open the door, as will be described further below.

In an alternative embodiment, when the delivery receptacle is empty it is unlocked and freely openable by the autonomous delivery vehicle without the need for any unlocking. But after the autonomous delivery vehicle unloads a delivery item into the delivery receptacle, the receptacle is locked, either automatically or in response to an affirmative locking action performed by the autonomous delivery vehicle, such as a locking via mechanical or magnetic key or in response to communication signal sent from the vehicle to the receptacle.

In an illustrative embodiment of the present disclosure, the autonomous delivery vehicle and the delivery receptacle are each configured to connect to each other via a docking process. The term “docking” in this context means that the autonomous delivery vehicle is securely physically coupled to the delivery receptacle. The docking connects the autonomous delivery vehicle to the delivery receptacle door-to-door in order to facilitate an efficient, orderly and secure transfer of the delivery item from the autonomous delivery vehicle to the delivery receptacle, and vice-versa when necessary. In one illustrative embodiment, the docking is achieved by locking the autonomous delivery vehicle to the delivery receptacle using hooks. In a second embodiment, the docking is achieved by locking the autonomous delivery vehicle to the delivery receptacle via magnetic force by employing magnets. In another embodiment, the docking is achieved by forming a tight seal between the door openings of the vehicle and the receptacle and creating a low-pressure environment inside the combined cavity using an air pressure regulating element in either the autonomous delivery vehicle or the delivery receptacle. Other methods of achieving the docking connection are possible as well.

In another embodiment of the present disclosure, the autonomous delivery vehicle does not physically dock to the delivery receptacle to the delivery receptacle in order to unload a delivery item, but instead uses what will be referred to herein as a “soft docking.” In a “soft docking,” the autonomous delivery vehicle positions itself adjacent to the delivery receptacle with the doors of the delivery vehicle and the delivery receptacle facing each other and, using proximity sensors, monitors the interpositioning of the autonomous delivery vehicle relative to the delivery receptacle and dynamically adjusts the positioning of the autonomous delivery vehicle so as to maintain an ideal juxtaposition of the vehicle to the receptacle for transferring the delivery item to the receptacle.

In one embodiment of the present disclosure, the delivery receptacle is “active,” meaning it has its own mechanical and/or electrical mechanism for opening and closing. In another embodiment, the delivery receptacle is “passive,” meaning it can only be opened via force applied either by the autonomous delivery vehicle or by a human user. In the embodiment wherein the delivery receptacle is active, the autonomous delivery vehicle instructs the receptacle to open itself by using a mechanical connection or by transmitting a wireless communication signal to the receptacle.

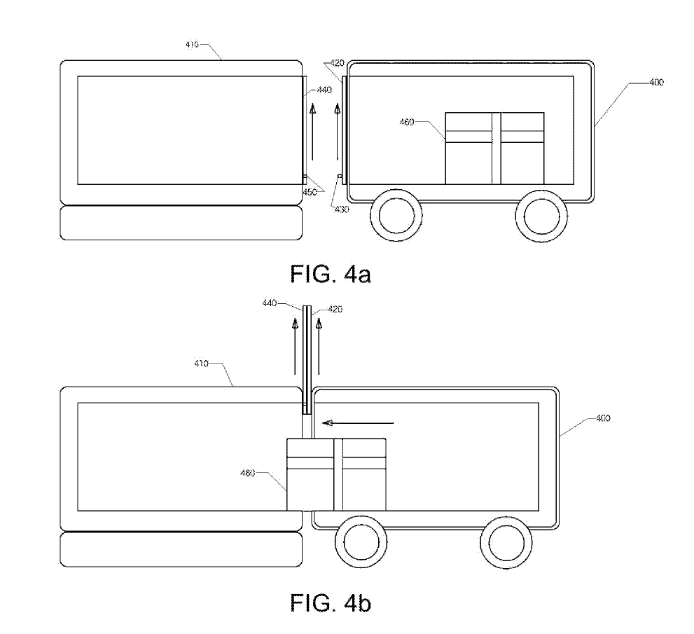

In one illustrative embodiment wherein the delivery receptacle is passive, the autonomous delivery vehicle is configured to dock to the delivery receptacle in such a way that the act of the autonomous delivery vehicle opening its own door also opens the door of the receptacle simultaneously. FIGS. 4a and 4b are plan views showing an autonomous delivery vehicle docking to a delivery receptacle and opening the delivery receptacle in accordance with an illustrative embodiment of the present disclosure. The autonomous delivery vehicle 400 has a sliding door 420 that opens vertically by sliding upwards. The autonomous delivery vehicle 400 opens and closes the door 420 autonomously, illustratively via an electric motor controlled by the vehicle's control system. The sliding door 420 includes an outwardly-extending member 430 disposed on the exterior side of the door. The delivery receptacle 410 also has a sliding door 440 that opens vertically by sliding upwards. The exterior side of the sliding door 440 of the delivery receptacle 410 includes a recess 450 that is configured to matingly engage with the outwardly-extending member of the sliding door 430 of the autonomous delivery vehicle 400. In operation, the autonomous delivery vehicle 400 positions itself adjacent the delivery receptacle 410 such that the outwardly-extending member 430 of the sliding door 420 of the autonomous delivery vehicle 400 matingly engages with the recess 450 of the sliding door 440 of the delivery receptacle 410. With the two sliding doors 420 and 440 thus physically engaged, the autonomous delivery vehicle 400 opens its sliding door 420, and along with it, the sliding door 440 of the delivery receptacle 410, as shown in FIG. 4b. With the sliding doors now open the autonomous delivery vehicle 400 transfers the delivery item 460 to the delivery receptacle 410.

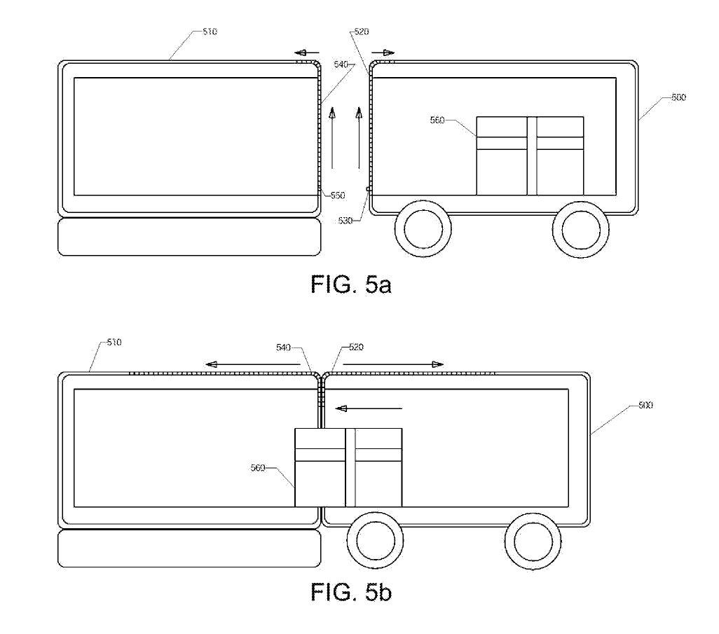

FIGS. 5a and 5b are plan views showing an autonomous delivery vehicle docking to a delivery receptacle and opening the delivery receptacle in accordance with another illustrative embodiment of the present disclosure. The autonomous delivery vehicle 500 has a moving shutter door 520 that opens vertically by sliding upwards. The autonomous delivery vehicle 500 opens and closes the door 520 autonomously, illustratively via an electric motor controlled by the vehicle's control system. The moving shutter door 520 includes an outwardly-extending member 530 disposed on the exterior side of the door. The delivery receptacle 510 also has a moving shutter door 540 that opens vertically by sliding upwards. The exterior side of the moving shutter door 540 of the delivery receptacle 510 includes a recess 550 that is configured to matingly engage with the outwardly-extending member of the moving shutter door 530 of the autonomous delivery vehicle 500. In operation, the autonomous delivery vehicle 500 positions itself adjacent the delivery receptacle 510 such that the outwardly-extending member 530 of the moving shutter door 520 of the autonomous delivery vehicle 500 matingly engages with the recess 550 of the moving shutter door 540 of the delivery receptacle 510. With the two sliding doors 520 and 540 thus physically engaged, the autonomous delivery vehicle 500 opens its moving shutter door 520, and along with it, the moving shutter door 540 of the delivery receptacle 510, as shown in FIG. 5b. With the sliding doors now open the autonomous delivery vehicle 500 transfers the delivery item 560 to the delivery receptacle 510.

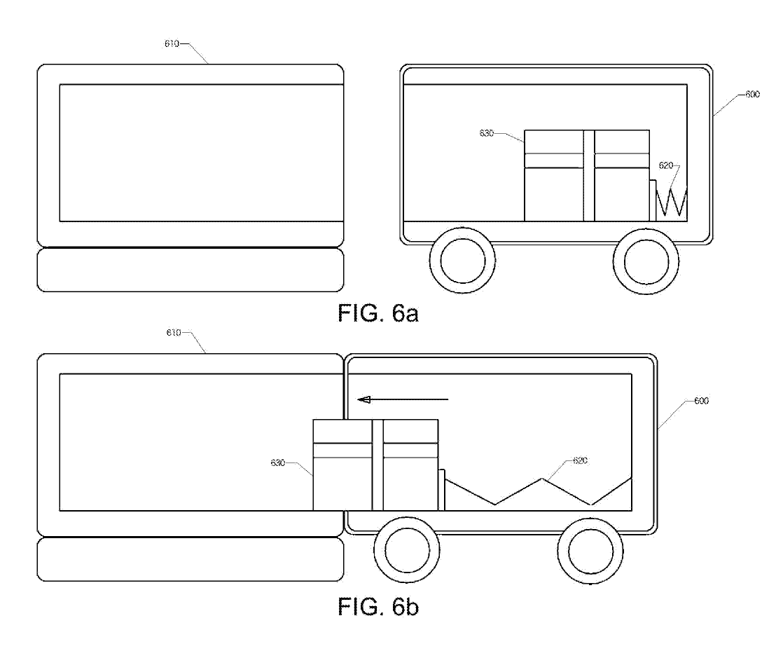

In an illustrative embodiment of the present disclosure, the autonomous delivery vehicle autonomously unloads a delivery item into the delivery receptacle using an electromechanical pushing arm, pushing shelf, or pushing spring. FIGS. 6a and 6b are plan views showing an autonomous delivery vehicle unloading a delivery item into a delivery receptacle using an electromechanical pushing arm in accordance with an illustrative embodiment of the present disclosure. The autonomous delivery vehicle 600 has a mechanical pushing arm 620 that is illustratively powered by an electric motor controlled by the vehicle's control system. In operation, after docking (or soft docking) with the delivery receptacle 610 and opening the doors of the autonomous delivery vehicle 600 and the delivery receptacle 610, the electromechanical pushing arm 620 of the autonomous delivery vehicle 600 pushes the delivery item 630 into the delivery receptacle 610, as shown in FIG. 6b.

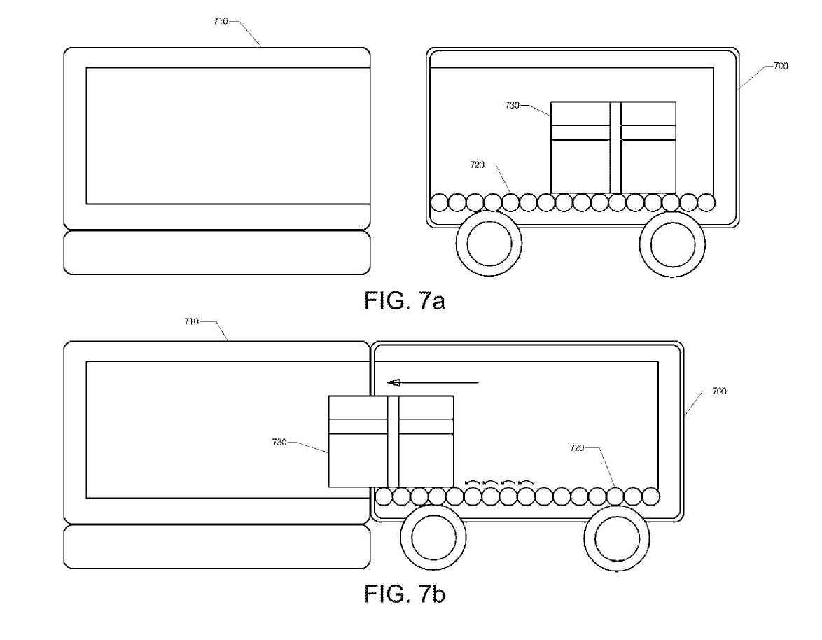

In another embodiment of the present disclosure, the autonomous delivery vehicle has a floor comprising rollers that autonomously unload the delivery item by rolling it into the delivery receptacle. FIGS. 7a and 7b are plan views showing an autonomous delivery vehicle unloading a delivery item into a delivery receptacle using a floor comprising rollers in accordance with an illustrative embodiment of the present disclosure. The autonomous delivery vehicle 700 has a floor comprising active rollers 720 that are illustratively powered by an electric motor controlled by the vehicle's control system. In operation, after docking (or soft docking) with the delivery receptacle 710 and opening the doors of the autonomous delivery vehicle 700 and the delivery receptacle 710, the rollers 720 of the autonomous delivery vehicle 700 roll the delivery item 730 into the delivery receptacle 710, as shown in FIG. 7b.

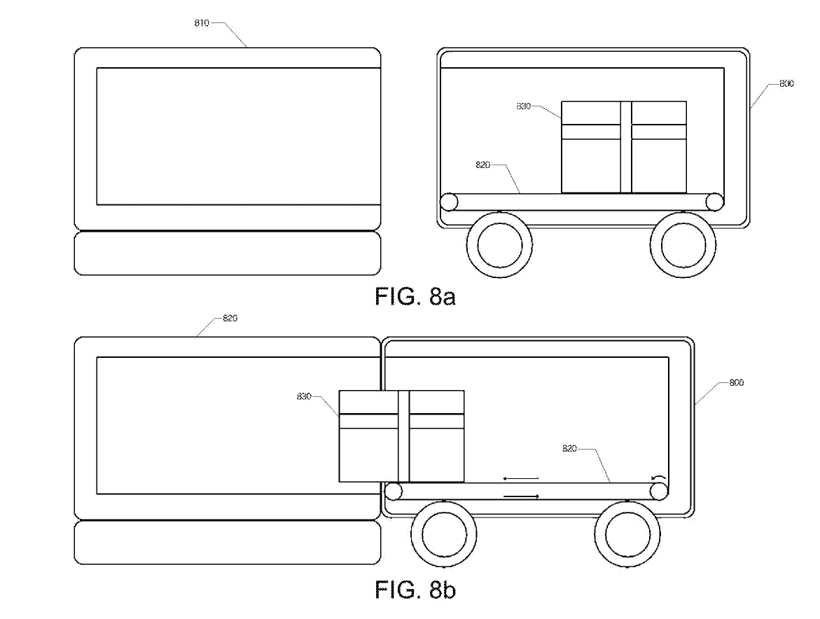

In another embodiment of the present disclosure, the autonomous delivery vehicle has a floor comprising a moving belt that autonomously unloads the delivery item into the delivery receptacle. FIGS. 8a and 8b are plan views showing an autonomous delivery vehicle unloading a delivery item into a delivery receptacle using a floor comprising a moving belt in accordance with an illustrative embodiment of the present disclosure. The autonomous delivery vehicle 800 has a floor comprising a moving belt 820 that is illustratively powered by an electric motor controlled by the vehicle's control system. In operation, after docking (or soft docking) with the delivery receptacle 810 and opening the doors of the autonomous delivery vehicle 800 and the delivery receptacle 810, the moving belt 820 of the autonomous delivery vehicle 800 moves the delivery item 830 into the delivery receptacle 810, as shown in FIG. 8b.

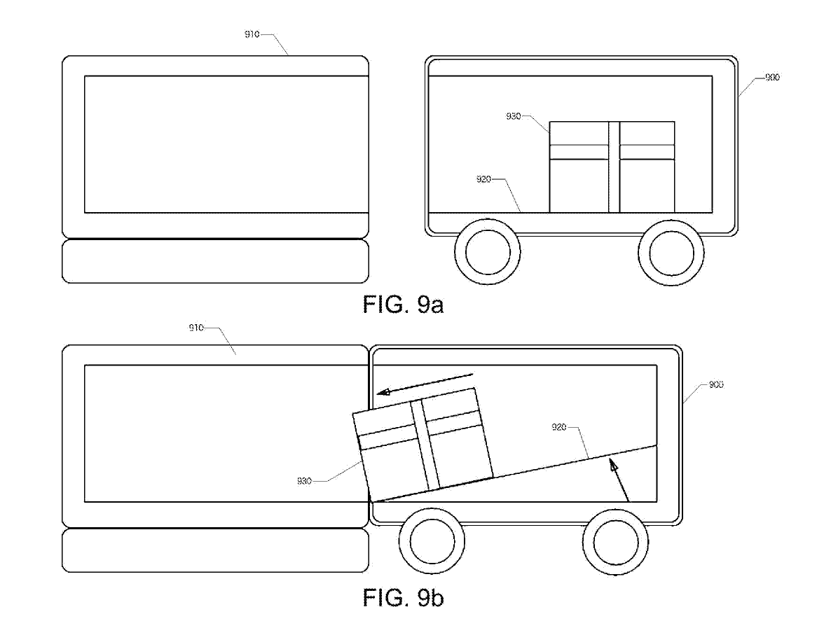

In another embodiment of the present disclosure, the autonomous delivery vehicle has an inclining floor that causes the delivery item to slide into the delivery receptacle. FIGS. 9a and 9b are plan views showing an autonomous delivery vehicle unloading a delivery item into a delivery receptacle using an inclining floor in accordance with an illustrative embodiment of the present disclosure. The autonomous delivery vehicle 900 has an inclining floor 920 that is illustratively powered by an electric motor controlled by the vehicle's control system. In operation, after docking (or soft docking) with the delivery receptacle 910 and opening the doors of the autonomous delivery vehicle 900 and the delivery receptacle 910, the end of the inclining floor 920 that is distal to the door of the autonomous delivery vehicle 900 is raised, causing the delivery item 930 to slide into the delivery receptacle 910, as shown in FIG. 9b.

In an illustrative embodiment of the present disclosure, the delivery receptacle also has unloading functionality that allows the delivery receptacle to autonomously transfer an item or items from the delivery receptacle to the autonomous delivery vehicle. In various embodiments, the delivery receptacle includes the same unloading functionality that the autonomous delivery vehicle is shown to have in FIGS. 6-9 as described above.

In another embodiment of the present disclosure, the autonomous delivery vehicle has a mechanical robotic arm that can pick up a delivery item from the storage compartment of the autonomous delivery vehicle and transfer it to the delivery receptacle. In an alternative embodiment, the delivery receptacle has a mechanical robotic arm that can pick up a delivery item from the storage compartment of the autonomous delivery vehicle and transfer it to the delivery receptacle, and that can pick up an item from the delivery receptacle and transfer it to the storage compartment of the autonomous delivery vehicle.

In an illustrative embodiment of the present disclosure, the delivery receptacle includes a delivery vehicle charging system that is operable to charge a battery of an autonomous delivery vehicle while the vehicle is docked to the delivery receptacle. The charging system is powered by electricity wired to the delivery receptacle or by a battery that provides power for the delivery receptacle. The charging system of the delivery receptacle includes a connector that can be located anywhere on a docking door or a docking surface of the delivery receptacle. A corresponding connector is correspondingly positioned on a docking door or a docking surface of the autonomous delivery vehicle such that the connector on the delivery vehicle electrically couples to the connector on the delivery receptacle automatically whenever the delivery vehicle is docked to the delivery receptacle.

In an illustrative embodiment of the present disclosure, the delivery receptacle is connected to a computer network such as the internet or to a local area network such as a Wi-Fi network. In further illustrative embodiments, the delivery receptacle includes sensors that can provide a range of capabilities. For example, in one embodiment, the delivery receptacle includes a scale system that is operable to weigh delivered items that are in the delivery receptacle. In another embodiment, the delivery receptacle has a sensor that senses whether the door of the delivery receptacle is open or closed. In another embodiment, the delivery receptacle includes a sensor that senses whether the door of the delivery receptacle is locked or unlocked. In another embodiment, the delivery receptacle includes a sensor that senses whether the delivery receptacle is empty or not. In another embodiment, the delivery receptacle has a temperature sensor that measures the temperature inside the delivery receptacle. In another embodiment, the delivery receptacle includes a motion sensor that can detect movement within the delivery receptacle. And in another embodiment, the delivery receptacle includes a chemical sensor that can detect the presence of various chemicals inside the delivery receptacle. The chemical sensor can be used to detect the presence of drugs or explosive chemicals. In an illustrative embodiment, the network connection of the delivery receptacle allows the various sensor readings to be read from a remote location, such as from inside a home or business associated with the delivery receptacle.

In an illustrative embodiment of the present disclosure, the delivery receptacle includes refrigerator and/or freezer capabilities. This embodiment is useful in cases where the delivery receptacle is used to receive grocery deliveries or other food deliveries. In an illustrative embodiment, the main compartment of the delivery receptacle includes a temperature control system that enables it to serve as a refrigerator and/or freezer. In another embodiment, the delivery receptacle includes one or more refrigerator/freezer compartments that are separate from the main compartment of the delivery receptacle. In one embodiment, a single refrigerator/freezer is provided that is capable of providing both refrigeration and freezing capabilities, while in another embodiment, the delivery receptacle includes a dedicated refrigerator unit and a dedicated freezer unit. In an illustrative embodiment, a control system of the delivery receptacle turns on the refrigerator or freezer unit automatically when an object is inside the unit, and turns it off when the unit is empty. In another embodiment, the refrigerator and/or freezer can be programmed for specific temperatures by the autonomous delivery vehicle or by a human user.

In one embodiment wherein the delivery receptacle is an “active” unit, i.e., includes components that require electricity to function, the delivery receptacle includes solar panels disposed on the top or on a side of the delivery receptacle. The solar panels charge an internal battery of the delivery receptacle to provide electrical power to the active components of the delivery receptacle.

In another embodiment of the present invention, the autonomous delivery vehicle autonomously unloads the delivery into a building structure via a dedicated delivery opening in an exterior wall of the building. In an illustrative embodiment, the dedicated delivery opening has a door or a gate regulating access to the delivery opening, while in another embodiment the delivery opening doesn't have any kind of door or gate. In an illustrative embodiment, the dedicated delivery opening leads to a dedicated delivery receptacle, while in another embodiment the dedicated delivery opening merely leads to an interior space of the building.

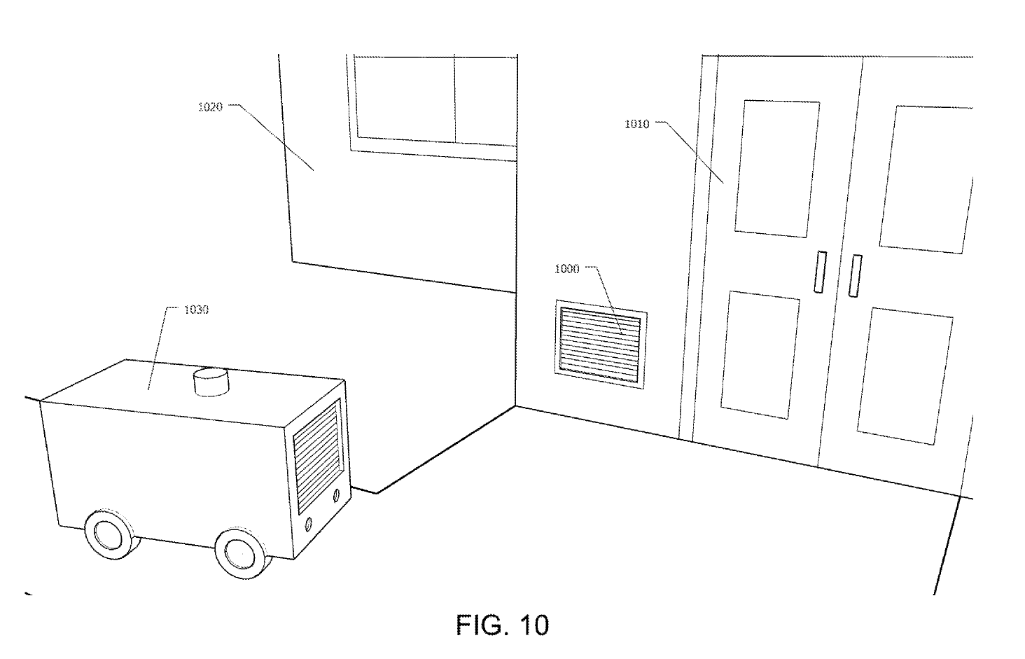

FIG. 10 is a perspective view of a dedicated delivery opening in an exterior wall of a house in accordance with an illustrative embodiment of the present disclosure. In FIG. 10, the dedicated delivery opening 1000 is located next to the front door 1010 of a house 1020. In the illustrative embodiment of FIG. 10, the dedicated delivery opening has a door regulating access to the delivery opening. The autonomous delivery vehicle 1030 is operable to autonomously unload one or more delivery items into the house 1020 through the dedicated delivery opening 1000. In various illustrative embodiments of the present disclosure, the autonomous delivery vehicle 1030 is capable of interacting with the dedicated delivery opening 1000 in the same ways that the autonomous delivery vehicle interacts with the delivery receptacle as described above with respect to, for example FIGS. 1-9. For example, in various illustrative embodiments, the autonomous delivery vehicle 1030 can dock to the dedicated delivery opening 1000 and its door and unload delivery items into the dedicated delivery opening 1000 in the ways described above with respect to FIGS. 4-9.

In another embodiment of the present invention, the autonomous delivery vehicle autonomously unloads delivery items into a building structure via a pre-existing opening in an exterior wall of the building, such as, for example, a window, a dog-flap or a cat-flap.

In another embodiment of the present invention, the autonomous delivery vehicle autonomously unloads the delivery through a dedicated delivery opening in a fence. In an illustrative embodiment, the dedicated delivery opening has a door or a gate regulating access to the delivery opening, while in another embodiment the delivery open doesn't have any kind of door or gate. In an illustrative embodiment, the dedicated delivery opening leads to a dedicated delivery receptacle, while in another embodiment the delivery receptacle merely leads to the other side of the fence.

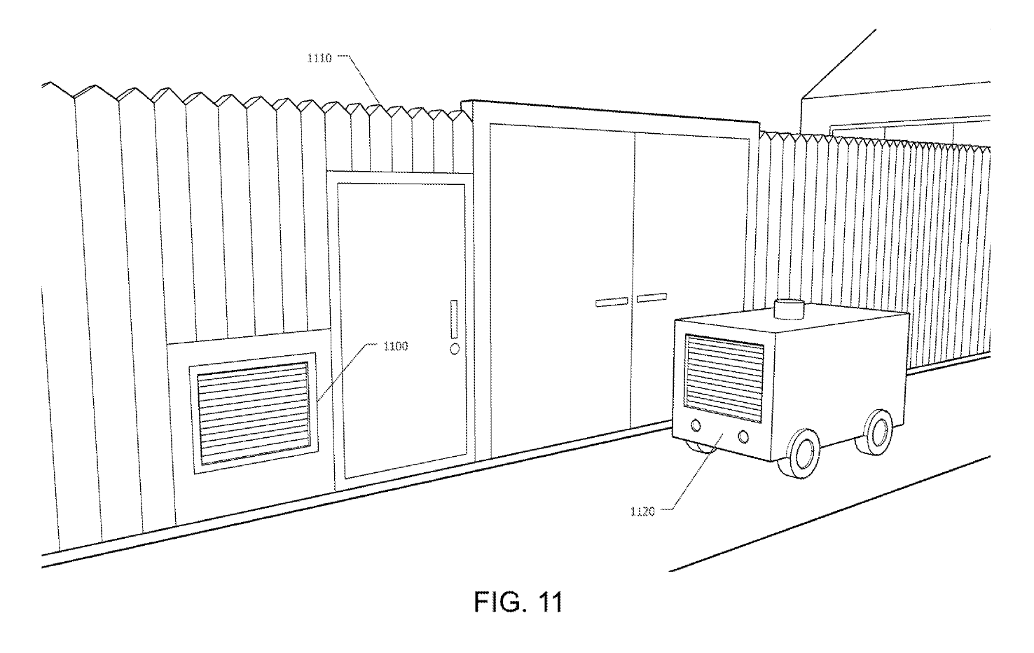

FIG. 11 is a perspective view of a dedicated delivery opening in a fence in accordance with an illustrative embodiment of the present disclosure. In the illustrative embodiment of FIG. 11, the dedicated delivery opening 1100 in the fence 1110 has a door regulating access to the delivery opening. The autonomous delivery vehicle 1120 is operable to autonomously unload one or more delivery items through the dedicated delivery opening 1100. In various illustrative embodiments of the present disclosure, the autonomous delivery vehicle 1120 is capable of interacting with the dedicated delivery opening 1100 in the same ways that the autonomous delivery vehicle interacts with the delivery receptacle as described above with respect to, for example FIGS. 1-9. For example, in various illustrative embodiments, the autonomous delivery vehicle 1120 can dock to the dedicated delivery opening 1100 and its door and unload delivery items into the dedicated delivery opening 1100 in the ways described above with respect to FIGS. 4-9.

In another embodiment of the present invention, the autonomous delivery vehicle autonomously unloads delivery items through a fence via a pre-existing opening in the fence such as, for example, a fence gate, or a dog-flap or a cat-flap.

In another embodiment of the present disclosure, a dedicated delivery container is provided which is configured to store one or more delivery items. The delivery container is carried by an autonomous delivery vehicle to effect the delivery of the delivery item(s) stored in the container. In an illustrative embodiment, the delivery container is specifically configured to be carried by the autonomous delivery vehicle, which is, in turn, specifically configured to carry the delivery container. The delivery container is designed to keep the delivery item(s) safe and protected from weather conditions. In an illustrative embodiment, the delivery container is insulated to keep delivery items cold or warm. In an illustrative embodiment the delivery container is reusable, while in an alternative embodiment the delivery container is intended for one-time usage.

The autonomous delivery vehicle transports the delivery container to a delivery location and autonomously unloads the delivery container at the delivery location. In one embodiment, the autonomous delivery vehicle autonomously unloads the delivery container near a door of a residence or place of business. In another embodiment, the autonomous delivery vehicle unloads the delivery container on a special marked unloading area that may be near a door or may be in another area adjacent the home or business. In other illustrative embodiments, the autonomous delivery vehicle autonomously unloads the delivery container into a building structure via a hole or a gate in an exterior wall of the building, or via a window, or via a dog-flap or a cat-flap.

In an illustrative embodiment of the present disclosure, a container docking station is located at a delivery location. The container docking station includes a container-securing mechanism for securely holding the delivery container in place on the docking station. In an illustrative embodiment, the delivery container also includes a securing mechanism that engages with the container-securing mechanism of the docking station in order to securely hold the delivery container in place on the docking station. In an illustrative embodiment, the container-securing mechanism of the docking station locks the delivery container to the container docking station such that the container-securing mechanism must be unlocked using for example, a mechanical key, or a magnetic key, or a wireless communication signal, to enable the container to be removed from the docking station. In a further embodiment, the locking mechanism of the container-securing mechanism also prevents the container from being opened. Thus the unlocking of the container-securing mechanism allows the delivery container to be removed from the docking station and opened by a human user.

In an illustrative embodiment, the autonomous delivery vehicle autonomously unloads the container to the container docking station by transferring the container to the docking station such that the container-securing mechanism of the docking station securely holds the delivery container in place. In an illustrative embodiment, the container-securing mechanism comprises a hook or hooks that engage with a recess or some other mechanical element on the delivery container to hold the delivery container in place. In another illustrative embodiment, the container-securing mechanism comprises a latch that engages with a latch or some other mechanical element on the delivery container to hold the delivery container in place.

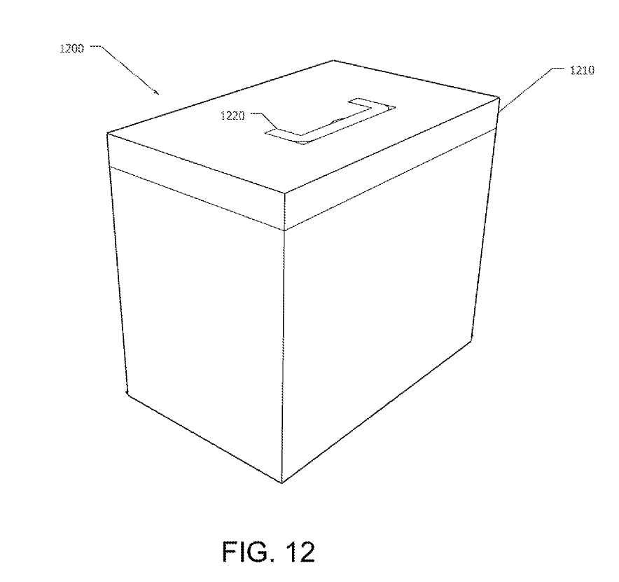

FIGS. 12-17 illustrate an example of an autonomous delivery vehicle unloading a delivery container to a container docking station in accordance with an illustrative embodiment of the present disclosure. FIG. 12 is a perspective view of a delivery container in accordance with an illustrative embodiment of the present disclosure. It is to be understood that the configuration of the delivery container 1200 shown in FIG. 12 is merely illustrative and that a delivery container can take on any of a number of forms and configurations in accordance with the present disclosure. The delivery container 1200 of FIG. 12 includes a lid 1210 and a handle 1220 that enables a human user to remove the lid 1210 and also enables a human user to carry the delivery container 1200.

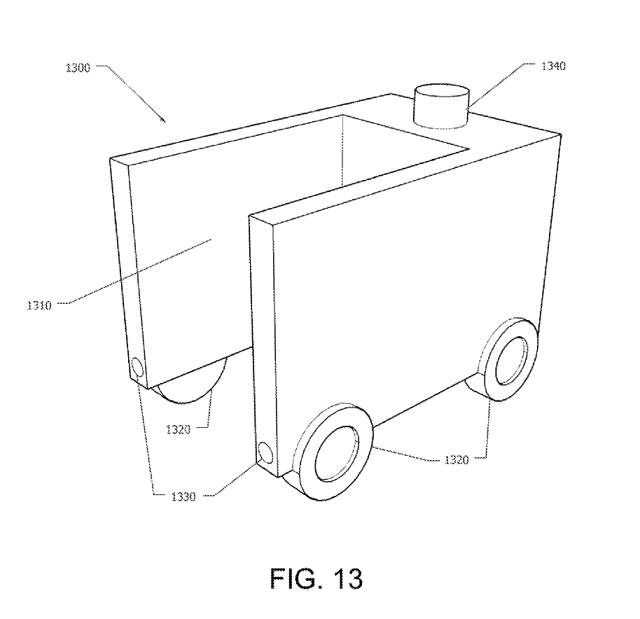

FIG. 13 is a perspective view of an autonomous delivery vehicle configured to deliver a delivery container in accordance with an illustrative embodiment of the present disclosure. It is to be understood that the configuration of the autonomous delivery vehicle 1300 shown in FIG. 13 is merely illustrative and that an autonomous delivery vehicle configured to deliver a delivery container can take on any of a number of forms and configurations in accordance with the present disclosure. The illustrative autonomous delivery vehicle 1300 includes a container-carrying portion 1310, wheels 1320, cameras 1330, and an optical sensor element 1340. The container-carrying portion 1310 is specifically configured to engage with and carry the delivery container 1200 of FIG. 12. The container-carrying portion 1310 can engage with and carry the container 1200 using any of a variety of means, including but not limited to any of a variety of mechanical elements, or via magnetic elements in the delivery vehicle 1300 that hold the delivery container in place via magnetic force. The cameras 1330 and the optical sensor element 1340 gather visual information on the physical surroundings of the autonomous delivery vehicle 1300. In an illustrative embodiment, the optical sensor element 1340 comprises a LiDAR sensor.

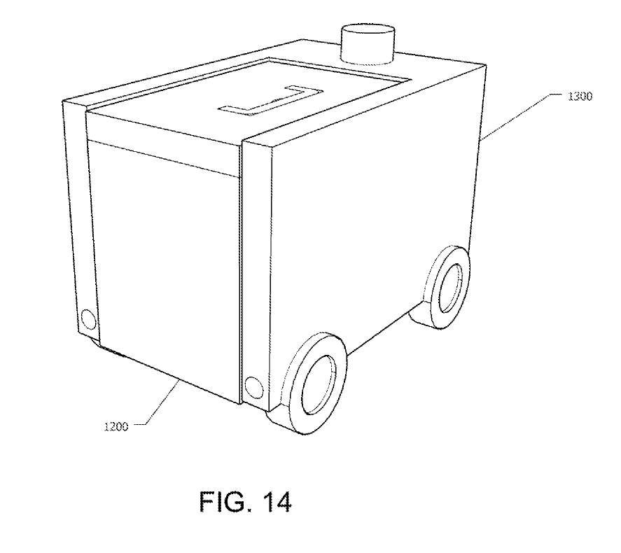

FIG. 14 is a perspective view of the autonomous delivery vehicle 1300 of FIG. 13 carrying the delivery container 1200 of FIG. 12 in accordance with an illustrative embodiment of the present disclosure.

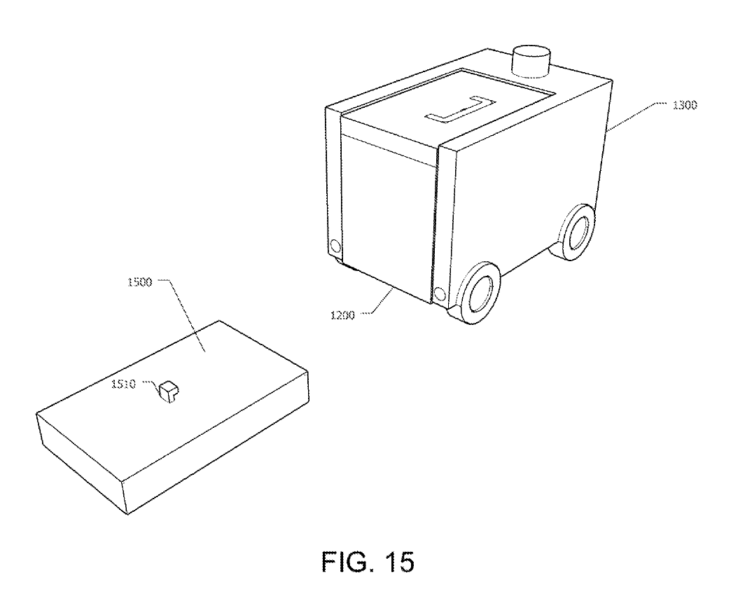

FIG. 15 is a perspective view of the autonomous delivery vehicle 1300 of FIG. 13 carrying the delivery container 1200 of FIG. 12 and approaching a container docking station 1500 in accordance with an illustrative embodiment of the present disclosure. The container docking station 1500 is disposed horizontally on the ground or on a floor and includes a container-securing mechanism 1510. The container-securing mechanism 1510 of the docking station 1500 comprises an upwardly extending member. The bottom of the delivery container 1200 includes a securing mechanism (not visible in FIG. 15) that comprises a recess or some other mechanical element configured to engage with the upwardly extending member of the container-securing mechanism 1510 to secure the delivery container 1200 on the docking station.

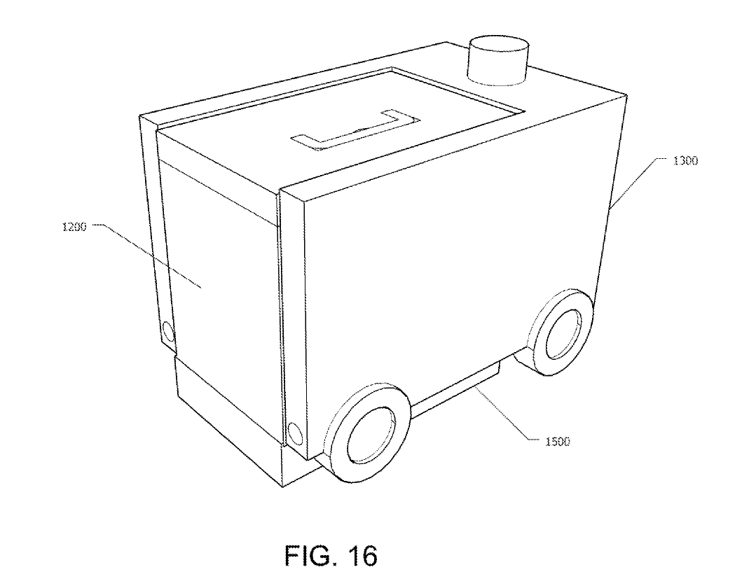

FIG. 16 is a perspective view of the autonomous delivery vehicle 1300 of FIG. 13 unloading the delivery container 1200 of FIG. 12 to the container docking station 1500 of FIG. 15 in accordance with an illustrative embodiment of the present disclosure. The autonomous delivery vehicle 1300 maneuvers over the container docking station 1500 such that the container-securing mechanism 1510 of the docking station engages with the securing mechanism on the bottom of the delivery container 1200.

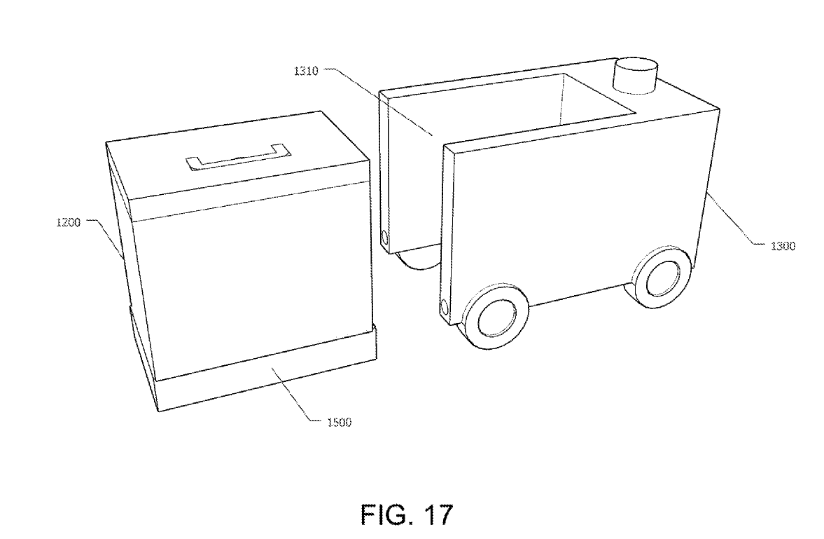

FIG. 17 is a perspective view of the autonomous delivery vehicle 1300 of FIG. 13 leaving the container docking station 1500 of FIG. 15 after unloading the delivery container 1200 of FIG. 12 in accordance with an illustrative embodiment of the present disclosure. After the container-securing mechanism 1510 of the docking station 1500 engages with the securing mechanism on the bottom of the delivery container 1200, the container-carrying portion of the autonomous delivery vehicle 1300 releases the delivery container and the delivery vehicle 1300 leaves the docking station.

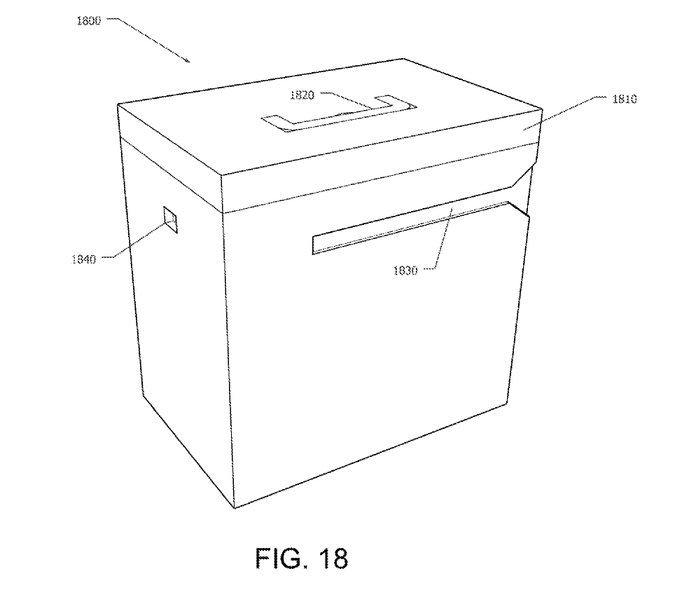

FIGS. 18-23 illustrate another example of an autonomous delivery vehicle unloading a delivery container to a container docking station in accordance with another illustrative embodiment of the present disclosure. FIG. 18 is a perspective view of a delivery container in accordance with an illustrative embodiment of the present disclosure. It is to be understood that the configuration of the delivery container 1800 shown in FIG. 18 is merely illustrative and that a delivery container can take on any of a number of forms and configurations in accordance with the present disclosure. The delivery container 1800 of FIG. 18 includes a lid 1810 and a handle 1820 that enables a human user to remove the lid 1810 and also enables a human user to carry the delivery container 1800. The delivery container 1800 has two recessed grooves 1830 on opposite sides of the delivery container that are configured to engage with container-carrying elements of an autonomous delivery vehicle (only one of the recessed grooves 1830 is visible in FIG. 18). The delivery container 1800 also includes a securing mechanism 1840 on a side of the delivery container that is between the sides that have the recessed grooves 1830. The securing mechanism 1840 comprises a recess configured to engage with a container-securing mechanism of a docking station to secure the delivery container to the docking station.

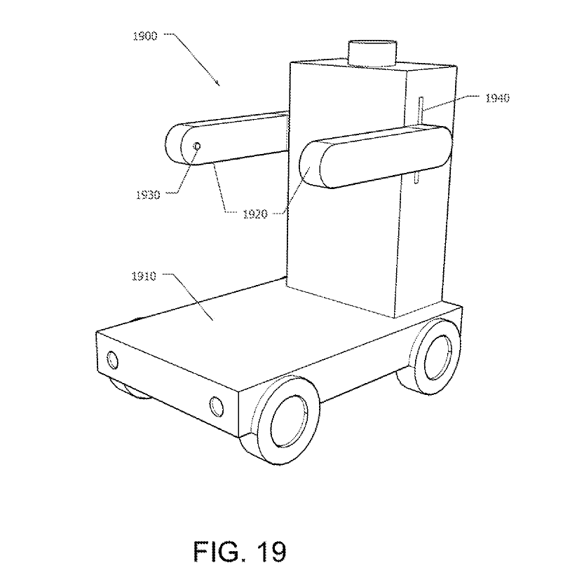

FIG. 19 is a perspective view of an autonomous delivery vehicle configured to deliver a delivery container in accordance with an illustrative embodiment of the present disclosure. It is to be understood that the configuration of the autonomous delivery vehicle 1900 shown in FIG. 19 is merely illustrative and that an autonomous delivery vehicle configured to deliver a delivery container can take on any of a number of forms and configurations in accordance with the present disclosure. The illustrative autonomous delivery vehicle 1900 includes a container-carrying platform 1910 and two container-carrying arms 1920. The container-carrying platform 1910 and the container-carrying arms 1920 are configured to carry a delivery container that is configured as the delivery container 1800 shown in FIG. 18. The container-carrying arms 1920 are configured to extend horizontally along two opposite sides of the delivery container 1800, so as to securely hold the delivery container 1800 on the container-carrying platform 1910. Each of the container-carrying arms 1920 have a groove-engaging member 1930 that protrudes slightly from the inside of each container-carrying arm (only one of the groove-engaging members 1930 is visible in FIG. 19). The groove-engaging members 1930 are configured to engage the recessed grooves 1830 on the delivery container. The container-carrying platform is intended to support most or all of the weight of the delivery container. In an illustrative embodiment, the container-carrying arms 1920 are coupled to vertical tracks 1940 on the autonomous delivery vehicle 1900. The container-carrying arms 1920 can slide up and down the tracks to accommodate delivery containers of varying sizes.

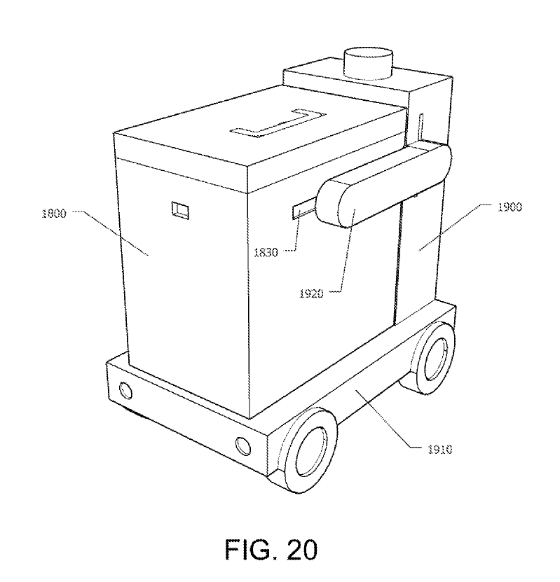

FIG. 20 is a perspective view of the autonomous delivery vehicle 1900 of FIG. 19 carrying the delivery container 1800 of FIG. 18 in accordance with an illustrative embodiment of the present disclosure. The delivery container 1800 is loaded onto the autonomous delivery vehicle 1900 by engaging the groove-engaging members 1930 of the container-carrying arms 1920 of the delivery vehicle 1900 with the recessed grooves 1830 in the sides of the delivery container and pushing the delivery container onto the container-carrying platform 1910. Or, alternatively, with the delivery container 1800 being held stationary, the autonomous delivery vehicle 1900 maneuvers to engage the recessed grooves 1830 in the sides of the delivery container with the groove-engaging members 1930 of the container-carrying arms 1920 of the delivery vehicle 1900. The autonomous delivery vehicle 1900 then maneuvers forward toward the delivery container to load the delivery container onto the container-carrying platform 1910.

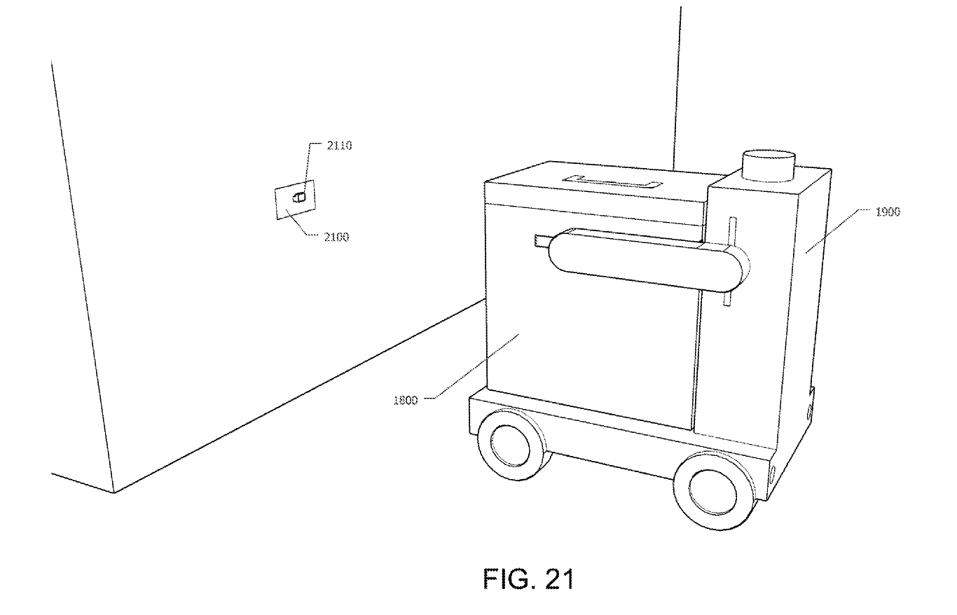

FIG. 21 is a perspective view of the autonomous delivery vehicle 1900 of FIG. 19 carrying the delivery container 1800 of FIG. 18 and approaching a container docking station 2100 in accordance with an illustrative embodiment of the present disclosure. The container docking station 2100 is disposed vertically on a vertical surface such as an external wall of a building. The container docking station 2100 includes a container-securing mechanism 2110 that comprises an outwardly extending member that is configured to engage with the recess of the securing mechanism 1840 of the delivery container 1800 to secure the delivery container 1800 to the docking station 2100.

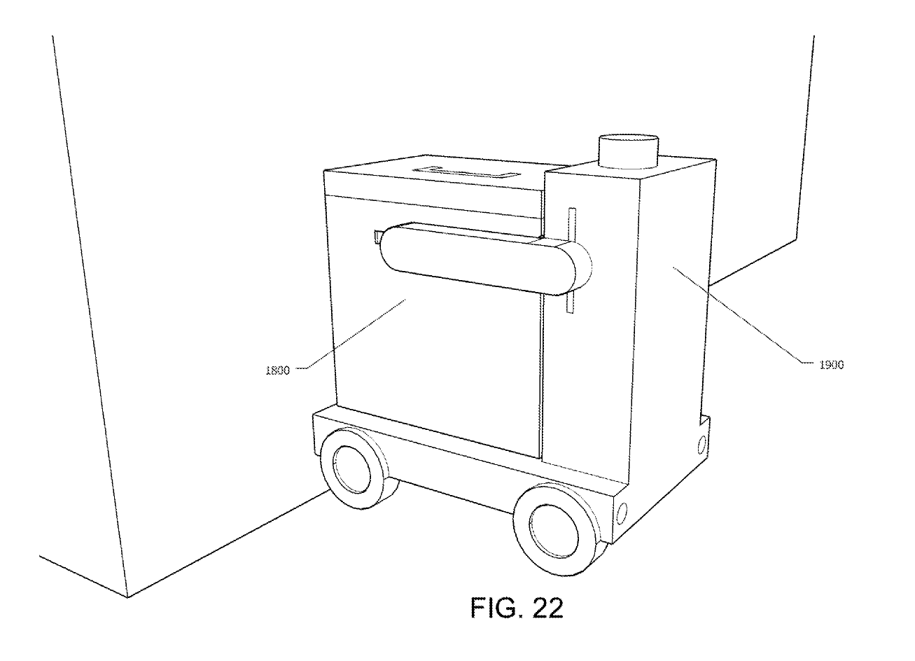

FIG. 22 is a perspective view of the autonomous delivery vehicle 1900 of FIG. 19 unloading the delivery container 1800 of FIG. 18 to the container docking station 2100 of FIG. 21 in accordance with an illustrative embodiment of the present disclosure. The autonomous delivery vehicle 1900 maneuvers the delivery container to the container docking station 2100 such that the container-securing mechanism 2110 of the docking station engages with the securing mechanism 1840 on the side of the delivery container 1800.

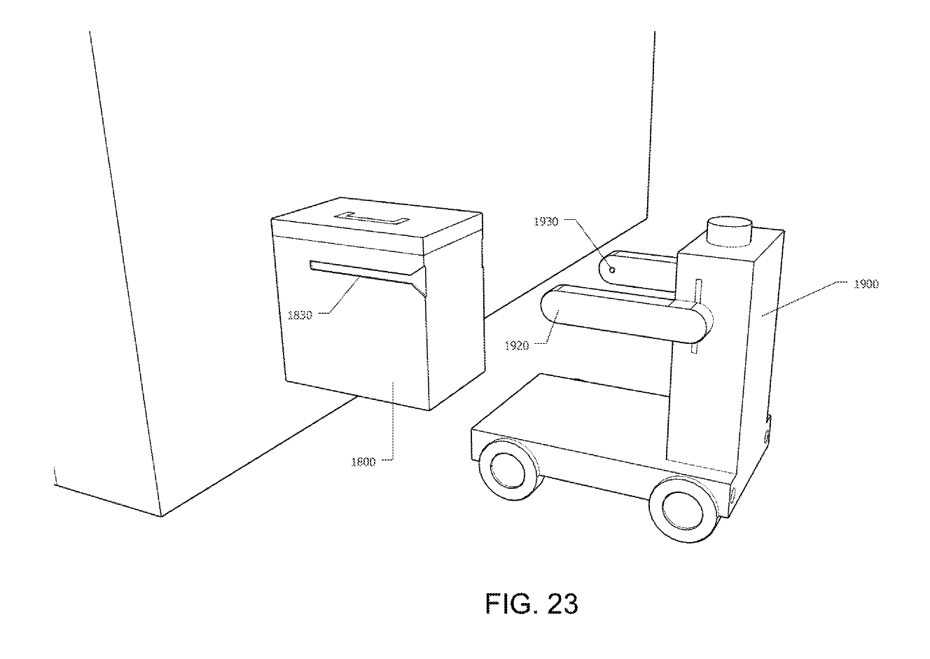

FIG. 23 is a perspective view of the autonomous delivery vehicle 1900 of FIG. 19 leaving the container docking station 2100 of FIG. 21 after unloading the delivery container 1800 of FIG. 18 in accordance with an illustrative embodiment of the present disclosure. After the container-securing mechanism 2110 of the docking station 2100 engages with the securing mechanism 1840 on the side of the delivery container 1800, the container-carrying arms 1920 of the autonomous delivery vehicle 1900 release the delivery container and the delivery vehicle 1900 backs away from the docking station. As the autonomous delivery vehicle 1900 backs away from the delivery container 1800 that is now docked to the docking station 2100, the groove-engaging members 1930 of the container-carrying arms 1920 of the delivery vehicle 1900 run along the recessed grooves 1830 of the delivery container 1800 until the delivery vehicle is fully disengaged from the delivery container 1800. As can be seen in FIG. 23, the container-securing mechanism 2110 of the docking station 2120 holds the delivery container securely against the wall such that the delivery container is suspended off the ground or floor, as the case may be.

In an illustrative embodiment of the present disclosure, a human user retrieves the delivered delivery container from the container docking station and removes the delivery items from the delivery container. In an illustrative embodiment, the human user can return the empty delivery container to the docking station. The empty delivery container can then be retrieved from the container docking station by an autonomous delivery vehicle.

In an illustrative embodiment of the present disclosure, the container docking station is connected to a computer network such as the internet or to a local area network such as a Wi-Fi network. In further illustrative embodiments, the container docking station includes sensors that can sense whether a docked delivery container is locked or unlocked, as well as sensors that can sense whether a docked delivery container is empty or not. In an illustrative embodiment, the network connection of the container docking station allows the sensor readings to be read from a remote location, such as from inside a home or business associated with the container docking station.

While some examples of an autonomous delivery system have been described in detail herein, it is to be understood that the inventive concepts may be otherwise variously embodied and employed and that the appended claims are intended to be construed to include such variations except insofar as limited by the prior art.

What is claimed is:

1. An autonomous delivery system comprising:
a delivery receptacle disposed at a delivery location;
an autonomous delivery vehicle operable to autonomously transport a delivery item to the delivery location and operable to autonomously transfer the delivery item to the delivery receptacle.

2. The autonomous delivery system of claim 1 wherein the autonomous delivery vehicle is operable to physically dock to the delivery receptacle to facilitate the autonomous transfer of a delivery item to the delivery receptacle.

3. The autonomous delivery system of claim 1 wherein the delivery receptacle comprises a delivery opening and wherein the autonomous delivery vehicle is operable to autonomously transfer the delivery item to the delivery receptacle through the delivery opening.

4. The autonomous delivery system of claim 3 wherein the delivery opening of the delivery receptacle comprises a door and wherein the autonomous delivery vehicle is operable to cause the door of the delivery receptacle to open and to securely close.

5. The autonomous delivery system of claim 4 wherein the autonomous delivery vehicle is operable to cause the door of the delivery receptacle to be locked and unlocked.

6. The autonomous delivery system of claim 5 wherein the delivery receptacle is operable to be unlocked by a human user.

7. The autonomous delivery system of claim 4 wherein the autonomous delivery vehicle comprises a door, and wherein the door of the autonomous delivery vehicle is configured to couple to the door of the delivery receptacle such that the autonomous delivery vehicle is operable to open and securely close the door of the delivery receptacle by opening and closing the door of the autonomous delivery vehicle.

8. The autonomous delivery system of claim 7 wherein the door of the autonomous delivery vehicle and the door of the delivery receptacle comprise sliding doors, and wherein the sliding door of the autonomous delivery vehicle is configured to couple to the sliding door of the delivery receptacle such that the autonomous delivery vehicle is operable to open and securely close the sliding door of the delivery receptacle by opening and closing the sliding door of the autonomous delivery vehicle.

9. The autonomous delivery system of claim 3 wherein the autonomous delivery vehicle is operable to instruct the delivery receptacle to open and close the delivery opening of the delivery receptacle.

10. The autonomous delivery system of claim 9 wherein the autonomous delivery vehicle is operable to instruct, via a wireless communication signal, the delivery receptacle to open and close the delivery opening of the delivery receptacle.

11. The autonomous delivery system of claim 1 wherein the delivery receptacle is integral with a building structure.

12. An autonomous delivery system comprising:
a dedicated delivery container configured to store one or more items to be delivered;
an autonomous delivery vehicle operable to autonomously transport the dedicated delivery container to a delivery location; and
a container docking station disposed at the delivery location and comprising a container-securing mechanism;
wherein the autonomous delivery vehicle is operable to transfer the dedicated delivery container to the container-securing mechanism of the container docking station such that the dedicated delivery container is secured in place by the container-securing mechanism.

13. The autonomous delivery system of claim 12 wherein the dedicated delivery container is specifically configured to be carried by the autonomous delivery vehicle.

14. The autonomous delivery system of claim 12 wherein the autonomous delivery vehicle is specifically configured to carry the dedicated delivery container.

15. The autonomous delivery system of claim 12 wherein the dedicated delivery container comprises a securing mechanism configured to engage with the container-securing mechanism of the container docking station to secure the dedicated delivery container in place on the container docking station.

16. The autonomous delivery system of claim 15 wherein the container docking station is disposed horizontally on one of the ground and a floor.

17. The autonomous delivery system of claim 15 wherein the docking station is disposed vertically on a wall of a building structure.

18. The autonomous delivery system of claim 15 wherein the container-securing mechanism of the container docking station comprises a first latch mechanism, and wherein the securing mechanism of the dedicated delivery container comprises a second latch mechanism configured to engage with the first latch mechanism of the container docking station to secure the dedicated delivery container on the container docking station.

19. The autonomous delivery system of claim 12 wherein the container-securing mechanism of the container docking station is configured to lock the dedicated delivery container to the container docking station.

20. The autonomous delivery system of claim 19 wherein the container-securing mechanism of the container docking station is operable to be unlocked by a human user.

21. An autonomous delivery system comprising:
an autonomous delivery vehicle operable to autonomously transport a delivery item; and
a dedicated delivery opening in an outer wall of a building structure;
wherein the autonomous delivery vehicle is operable to autonomously transfer the delivery item through the dedicated delivery opening in the building structure.

22. The autonomous delivery system of claim 21 wherein the dedicated delivery opening opens into a delivery receptacle inside the building structure.

23. The autonomous delivery system of claim 21 wherein the autonomous delivery vehicle is operable to physically dock to the dedicated delivery opening.

24. The autonomous delivery system of claim 21 wherein the dedicated delivery opening comprises a door and wherein the autonomous delivery vehicle is operable to cause the door of the delivery opening to open and to securely close.

25. The autonomous delivery system of claim 24 wherein the autonomous delivery vehicle is operable to cause the door of the delivery opening to be locked and unlocked.

26. The autonomous delivery system of claim 25 wherein the door of the delivery opening is operable to be unlocked by a human user.

27. The autonomous delivery system of claim 24 wherein the autonomous delivery vehicle comprises a door, and wherein the door of the autonomous delivery vehicle is configured to couple to the door of the dedicated delivery opening such that the autonomous delivery vehicle is operable to open and securely close the door of the dedicated delivery opening by opening and closing the door of the autonomous delivery vehicle.
